(19) United States
(12) Patent Application Publication
(10) Pub. No.: US 2006/0015772 A1
(43) Pub. Date: Jan. 19, 2006

(54) Reconfigurable memory system

(76) Inventors: Boon Seong Ang, Sunnyvale, CA (US); Michael Schlansker, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/892,305

(22) Filed: Jul. 16, 2004

(51) Int. Cl. G06F 11/00

(52) U.S. Cl. 714/7

(57) ABSTRACT

A reconfigurable memory system includes processors and memory modules. A reconfiguration system is operable to reconfigure the memory system into multiple configurations. In each configuration, one or more memory modules are provisioned for each processor.

### BACKGROUND

A memory system is a key component of any computing system. The manner in which memory is organized or configured has a fundamental influence on performance, functionality and cost. This is true of general purpose computing systems, such as a desktop computer or an enterprise class server, as well as special purpose computing systems, such as found in digital appliances like digital camcorders and cameras, or in a DVD player.

Different memory organizations may have widely varying characteristics. Some such characteristics may be related to memory ports, such as the number of ports, whether a port is a read port, whether a port is a write port, whether a port is both a read and write port or a port supporting other memory based operations like swap or ready-modify-write. There is also variability in the width of each port, total memory size, and the way memory is addressed. Another increasingly important variability relates to security. A memory system may be provided with sophisticated security features enforcing rules governing which processor is allowed to access what portions of a memory system.

Traditionally, memory systems have organizations that are fixed once the hardware is built and assembled. While this affords a certain level of simplicity when using the constructed system, it has no flexibility to adjust the memory organization to meet the needs of different applications using the hardware. The flexibility to customize memory organization is particularly useful in computing systems having multiple processors or functional blocks but is not provided by conventional memory systems. The following are two examplary application contexts where this flexibility to adjust memory organization, which is not provided by conventional memory systems, can lead to new capabilities, higher performance, and reduced cost.

One application context is in a utility computing platform. A utility computing platform includes a hardware platform with a collection of compute, memory, and I/O resources that is allocated on-demand to serve the needs of multiple, likely different applications that furthermore vary over time. Sharing the platform leads to greater efficiency and hence lower cost.

Very often, multiple copies of possibly different operating systems are simultaneously running on a utility computing platform. For both functional as well as security reasons, each instance of the operating system wants its own address space, which should not be accessible to another operating system. In general, each operating system prefers or may even require a contiguous range of addresses, often starting from 0. The amount of memory needed by each running instance of operating system can also vary, depending on the applications running on the operating system.

The memory system in general purpose computing systems today do not match this requirement for flexible memory allocation to concurrently running operating systems. Utility computing platforms implemented with these existing systems either has to function with a fixed partitioning of memory resources determined at hardware assembly time, or a software layer, such as found in a virtual machine monitor, is used to emulate a partitioned memory system. Such emulation incurs overhead that reduces performance, and often has security vulnerabilities.

Another application context is in reconfigurable devices. Reconfigurable devices are hardware devices that can be configured to take on different hardware designs after the device is fabricated. FPGAs (Field Programmable Gate Arrays) is an example of a reconfigurable device. Early FPGAs offer the ability to configure arbitrary logic and small amount of flip-flop memory into different hardware design. Subsequently, memory RAM blocks are incorporated into FPGAs. Under the envisioned usage mode taught by FPGA designers, the RAM blocks provide flexibility for configuring into multiple logical memory systems, each with configurable word width and total size. This configurability is achieved through the way address signals and data paths are wired to the memory blocks. While this approach enables a certain degree of configurability, its flexibility is still limited. For instance, it is impossible for the traditional FPGA block RAM design to flexibly share a physical RAM block between two or more logical memory organizations, each with its own addressing scheme. It is apparent that fixed memory organizations and the limited configurability in FPGA block RAMs is inadequate for many applications.

### SUMMARY

A reconfigurable memory system includes processors and memory modules. A reconfiguration system is operable to reconfigure the memory system into multiple configurations. In each configuration, one or more memory modules are provisioned for each processor.

### BRIEF DESCRIPTION OF THE DRAWINGS

The embodiments are illustrated by way of example and without limitation in the accompanying figures in which like numeral references refer to like elements, and wherein:

FIG. 1 shows a schematic diagram of a system for configuring a reconfigurable memory system, according to an embodiment;

FIG. 2 shows a schematic diagram of a reconfigurable memory system, according to an embodiment;

FIGS. 3A-C show schematic diagrams of memory spaces available to a reconfigurable memory system at times t1-t3, according to an embodiment;

FIGS. 4A-B shows schematic diagrams of address translation units, according to embodiments;

FIG. 5 shows a schematic diagram of an interconnection network, according to an embodiment;

FIGS. 6A-B show schematic diagram of a memory module, according to an embodiment;

FIG. 7A shows a schematic diagram of an address manipulation unit, according to an embodiment;

FIG. 7B shows an example of local addresses in a memory module, according to an embodiment;

FIG. 8 shows a flow diagram of an operational mode of a reconfigurable memory system, according to an embodiment;

FIG. 9 shows a flow diagram of another operational mode of a reconfigurable memory system, according to an embodiment; and

FIG. 10 shows a flow diagram of a method for reconfiguring a memory system, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

A reconfigurable memory system, comprised of memory modules, address translation units, processors and an interconnection network allow a user to configure any number of memory modules into a memory organization available for use by a processor group. A memory module refers to a unit of memory managed by a memory controller. Each memory module contains storage cells, also referred to as memory locations, which are the physical media that store data for one or more processor groups. A processor group may include a set of processors that together share one physical address space. Instead of a set of processors, a processor group may include a single processor. A processor refers to a processor that runs software and/or hardware whose functions are hardwired or configured into the hardware instead of executing software to perform the functions. In each memory access operation, such as a read or write request, a processor specifies a physical address to reference one or more specific memory locations allocated to the processor for the memory configuration.

The reconfigurable memory system allows the decoupling of the fabrication and assembly of the memory system from the configuration of the memory system. The reconfigurable memory system can be configured into many possible memory configurations, also referred to as memory organizations, and reconfigured over time. For example, a user may determine that an application needs a processor with access to a very large amount of memory. The reconfigurable memory system is configured so that several of the memory modules are designated to the processor. That is several of the memory modules are provisioned for the processor. The reconfigurable memory system provides appropriate address translation schemes and memory traffic propagation mechanisms so that a memory access issued by the processor results in appropriate action at one or more memory storage cells in the memory modules. In effect, the reconfigurable memory system hides the details of the underlying memory infrastructure from the processor which only sees its physical address space.

If the user later determines that the application requires less memory, the memory system may be reconfigured provisioning some of the previously used memory modules to other processors. The reconfiguration may be done programmatically avoiding physical movement of hardware. This provides several benefits to a user. For example, the flexibility of the reconfigurable memory system allows the user to quickly configure memory organizations as needs arise. Additionally, the user may efficiently deploy resources according to changing requirements.

In general, a reconfigurable memory system may be configured to concurrently support multiple memory organizations serving multiple processor groups. When multiple memory organizations are configured in a reconfigurable memory system, each organization has its own physical address space. When two processors share a physical address space, i.e. they belong to the same processor group, they share the same set of memory storage locations and both use the same physical address to refer to the same memory storage location. When two processors belong to different processor group, each has a distinct physical address space. This means that a physical address “x” refers to one memory location when specified by one processor in a first processor group, but may refer to a different memory location when specified by another processor in a different processor group.

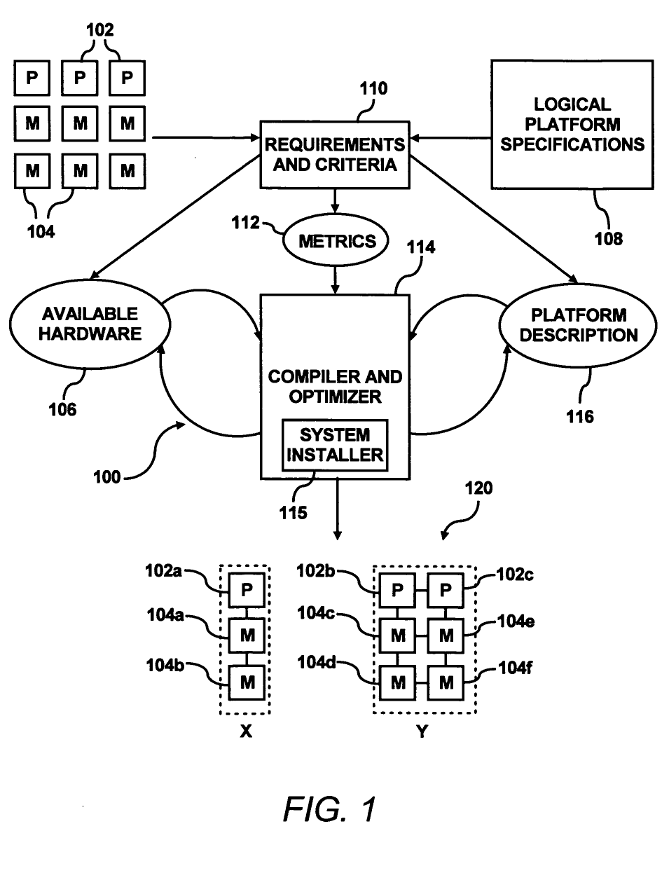

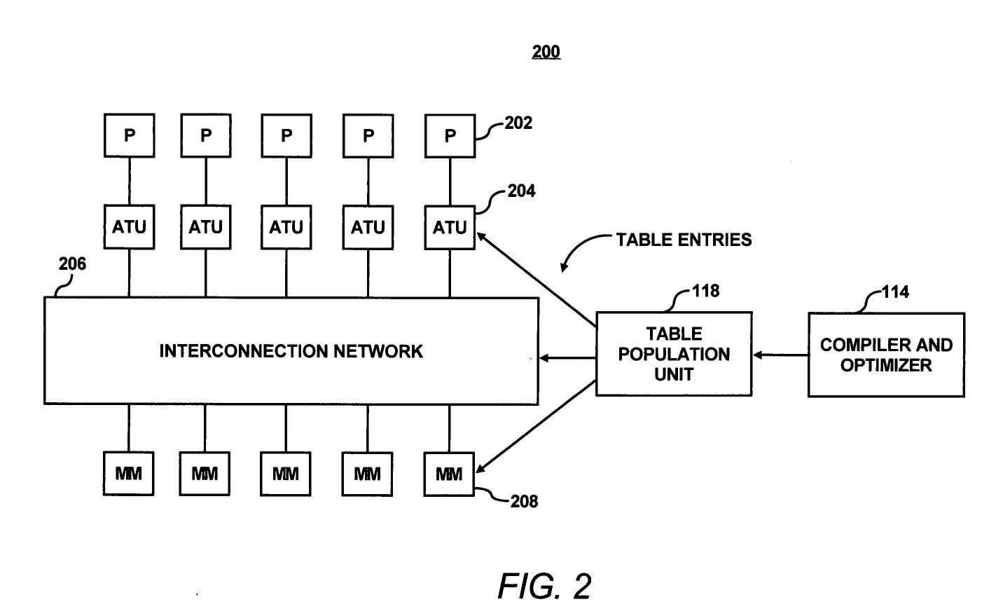

With reference first to FIG. 1, there is shown a schematic diagram of a system 100 for configuring a reconfigurable memory system. The reconfigurable memory system is also shown in FIG. 2 as the reconfigurable memory system 200. The system 100 of FIG. 1 has access to a pool of processors 102 and the memory modules 104 which may be configured by the system 100. The pool of processors 102 and the memory modules 104 are represented as a list of available hardware 106 for input to the system 100 along with a list of logical platform specifications 108 which together make up the requirements and criteria 110 for configuring the available hardware 106. A list of metrics 112 is also input into the system 100.

The system 100 then uses a compiler and optimizer 114 to determine how the available hardware 106 should be configured. This configuration is represented as a platform description 116 which is tested to determine if the platform will meet the requirements and criteria 110 and work within the metrics 112. If not, the compiler and optimizer 114 generate another configuration of the pool of processors 102 and memory 104 for testing. This process is continued until a configuration satisfying the metrics 112 and requirements and criteria 110 is found. The system 100 then deploys the configuration, shown as the physical configuration 120. The compiler and optimizer 114 may include a system installer 115 for deploying the physical configuration 120. The system installer 115 may also be a separate component from the compiler and optimizer 114 but connected to the compiler and optimizer 114. Deploying may include populating tables (e.g., addressing tables) in hardware components and the interconnection network (e.g., routing tables), which is described below and is further described in U.S. Patent Application Serial Number TBD (Attorney Docket No. 200314982-1), incorporated by reference in its entirety. In the example shown in FIG. 1, the system 100 configured one processor 102a to access two memory modules 104a and 104b and configured two processors 102b and 102c, now a processor group, to operate as a multiprocessor system and access four memory modules 104c, 104d, 104e and 104f. Thus, the system 100 provides for reconfiguring hardware based on input specifications, which allows the hardware to be optimized for multiple applications among other things.

The previous description is one method of determining how the reconfigurable memory system 100, shown in FIG. 1, may be configured. The determination of how to configure memory may be made in other ways including, but not limited to: a manual determination, heuristic processing, artificial intelligence optimizers or the like. In addition, a user may layout the configuration on a console which then is used to configure the reconfigurable memory system 100.

Referring now to FIG. 2, there is shown a schematic diagram of the reconfigurable memory system 200, according to one embodiment. The pool of processors 102 and memory modules 104 shown in FIG. 1 may be connected using the components shown in FIG. 2 to allow the memory modules 104 to be reconfigured as needed. FIG. 2 illustrates components for connecting processors 202, which may include the processors 104 shown in FIG. 1, to memory modules 208, which may include the memory modules 104 shown in FIG. 1. Connected and coupled as used herein refers to components or devices being in electrical communication. The electrical communication may be via one or more other components or may simply be solely between the components sending and receiving information.

Specifically, the reconfigurable memory system 200 includes the plurality of processors 202 which may be arranged in processor groups, a plurality of address translation units 204, an interconnection network 206 and the plurality of memory modules 208. Each of the processors or processor groups 202 may be coupled to one of the address translation units 204 via a network, a bus or any other system for transmitting signals not shown. A processor and an address translation unit both transmit and receive signals including requests for data to be read from a memory location in one or more of the memory modules 208, requests for data to be written to a memory location in one or more of the memory modules 208, and the data to be read or written from or to one or more of the memory modules 208.

When configured, the processors 202 are coupled to the address translation units 204 which are in turn coupled to the interconnection network 206. The address translation units 204 receive requests from the processors 202, which may include physical addresses for performing data operations, such as reads or writes. The address translation units 204 convert the physical address into a form that assist subsequent handling of the request. For example, the output of the conversion at the address translation units 204 may direct the propagation of the requests through the interconnection network 206. The conversion output may also simplify the identification of the memory locations in the responding memory modules 208. The address translation units 204 may also perform additional coordination functions when multiple memory modules 208 respond to a memory request.

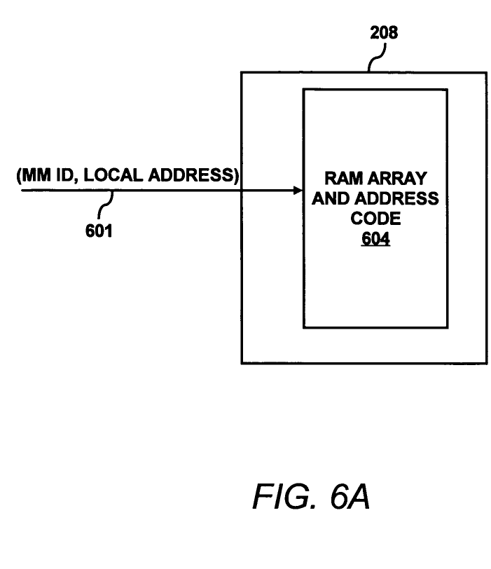

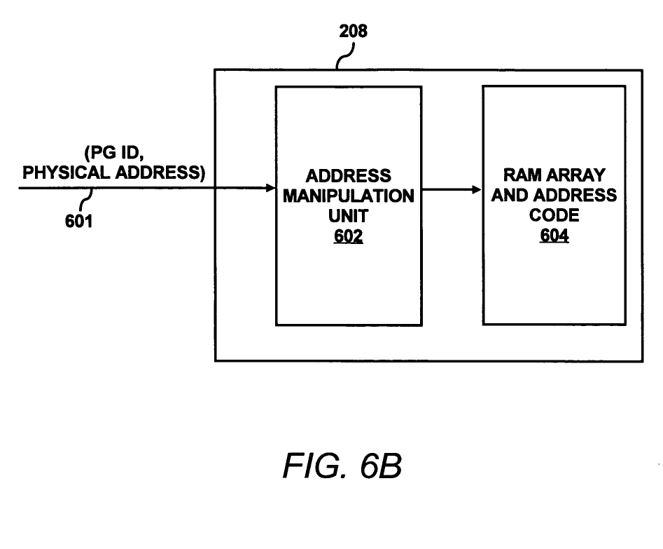

The interconnection network 206 is configured to receive, route and transmit signals including requests for data to be read from a memory location, requests for data to be written to a memory location and the data to be read from or written to one or more of the memory modules 208. The interconnection network 206 routes requests to appropriate memory modules 208. The memory modules 208 receive read or write requests and respond to the requests via the interconnection network 206. Although not shown in FIG. 2, the memory modules may include or be coupled to address manipulation units, such as shown in FIG. 6. The address manipulation units may perform additional address conversion and control functions to determine the memory locations targeted by each memory request, and to carry out the required actions at the appropriate times. Certain embodiments may not use the address manipulation units, such as when each request output from an address translation unit includes a memory module ID and local addresses as described in further detail below.

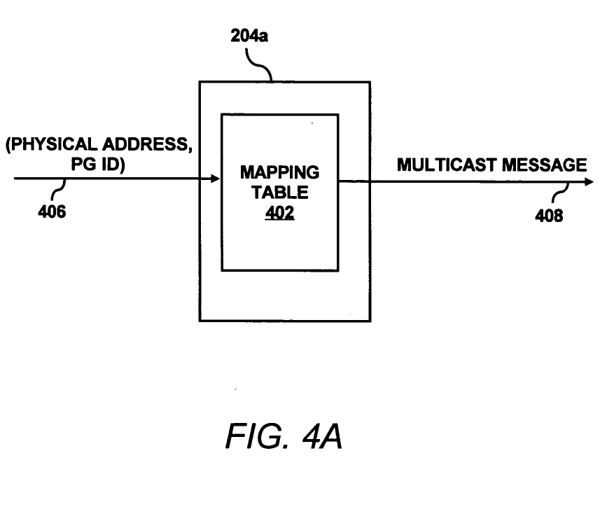

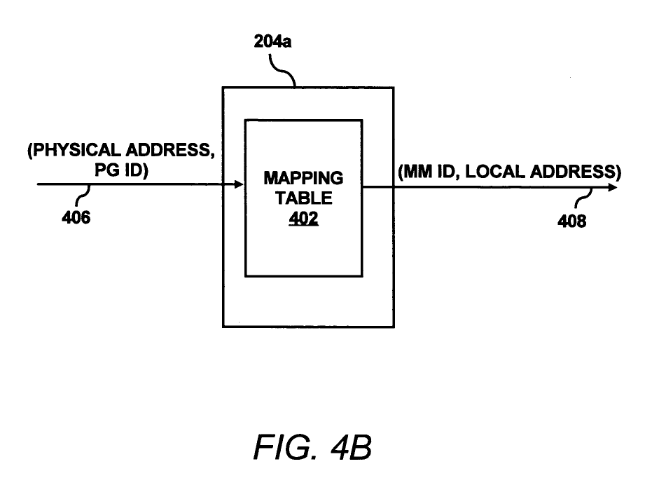

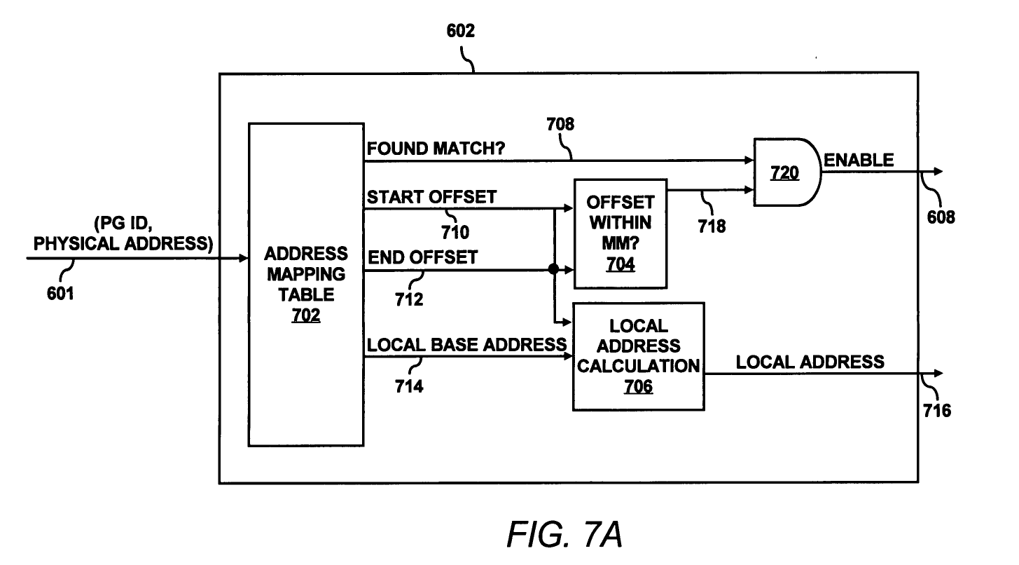

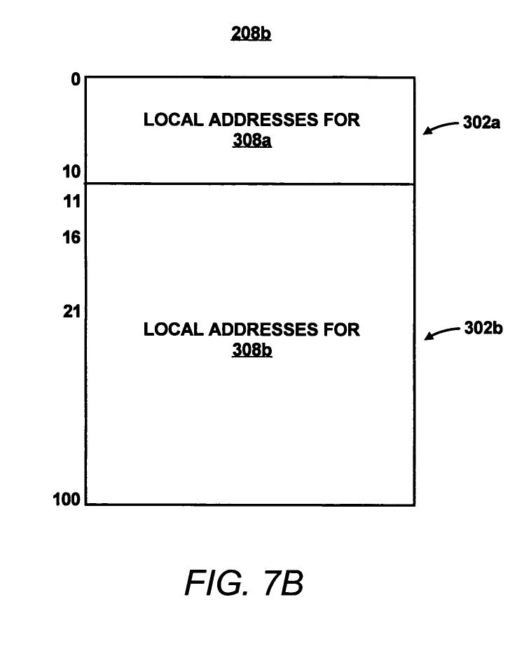

The processors 202 and memory modules 208 may be reconfigured using the system 100 shown in FIG. 1. Thus, the processors 202 may be coupled to different memory modules 208 after various configurations. In order to make changes to the memory configurations transparent to the processors 202 and to provide a contiguous set of memory addresses for the processors 202 if needed, the address translation units 204, the interconnection network 206, and possibly the address manipulation units in the memory modules 208 convert addresses provided in data requests from the processors 202 to addresses in the memory modules 208 where the data may be read or written and the interconnection network 206 routes requests to the appropriate memory module. Configuring the reconfigurable memory system involves setting up the address translation units 204, the interconnection network 206, and possibly the address manipulation units 209 appropriately. Address conversion tables may be provided in the one or more of the address translation units 204, nodes in the interconnection network 206 and in the memory modules 208. Values in these address conversion tables are changed. For example, physical addresses and offsets are received from the table population unit 118 shown in FIG. 2 to accommodate the new configuration. Address conversion may then be performed by table lookup and/or adding to or subtracting from a new offset received from the table population unit 118. In this example, the compiler and optimizer 114 shown in FIG. 1 determines the configuration for the memory modules 208. Also, an address translation unit may be shared by multiple processors. However, a shared address translation unit includes one or more mapping tables that may be used for address conversion for each processor using the address translation unit. The compiler and optimizer 114 is connected to the table population unit 118 which loads the address conversion tables with the appropriate entries (e.g., physical addresses and offsets) depending on how the memory modules 208 are configured. The address conversion tables are described in further detail below with respect to the mapping table 402 shown in FIGS. 4A-B and the address mapping table 702 shown in FIG. 7A, both of which are examples of address conversion tables.

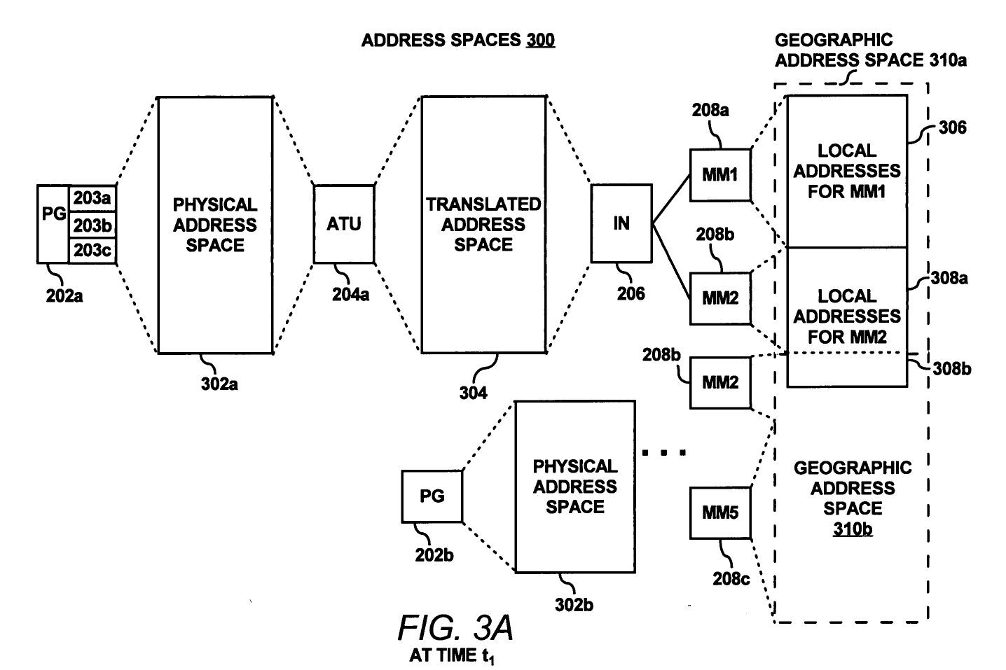

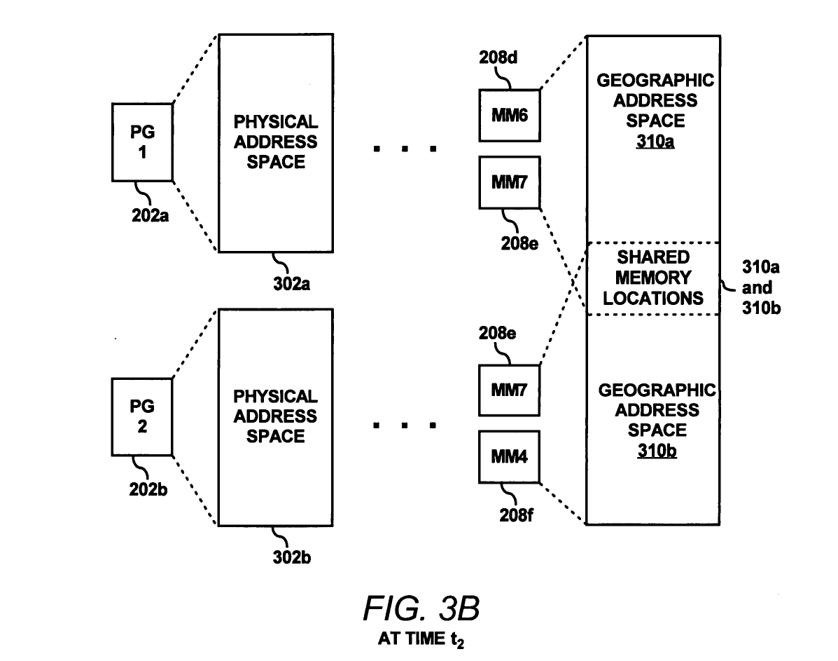

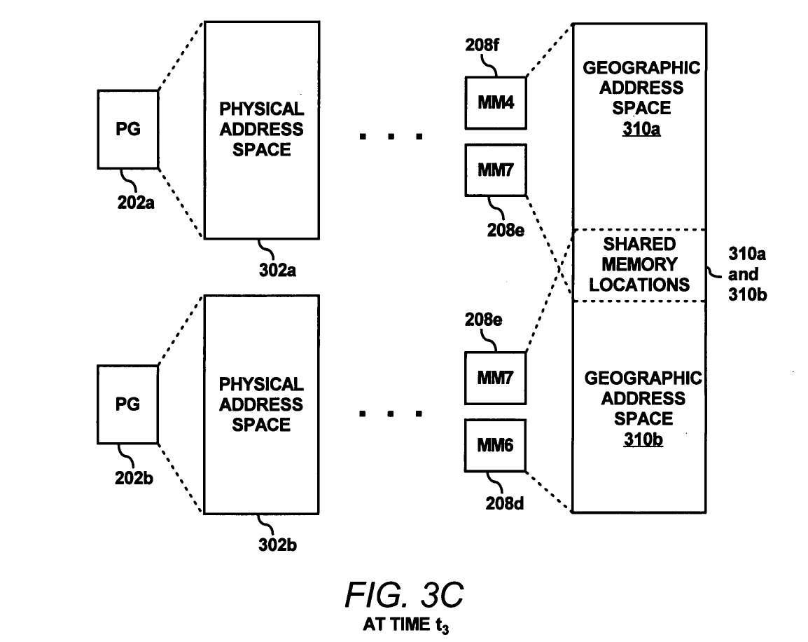

Throughout the present disclosure reference is made to the different types of addresses including physical address, local address and translated address. Reference is also made to address spaces, i.e., a collection of addresses associated with each type of address, such as the physical address space, local address space and the translated address space. All these are terminologies to assist in the description of the embodiments and in no way limit the scope of the embodiments. Also, these address spaces are shown and described again with respect to FIGS. 3A and 3B.

A physical address is the address specified in a memory request issued by a processor. Each processor group shares a common physical address space, while different processor groups that are operating concurrently on a reconfigurable memory system have separate physical address spaces. Two processors having the same address space means every address refers to the same memory location for both processors. Two processors having different address spaces means there exists an address that refers to one memory location when used by one processor, but refers to a different memory location when used by the other processor.

Two physical address spaces may be completely separate, with not a single memory location shared between them. Alternatively, two physical address spaces may share some common memory locations. In that case, a shared memory location may be referenced with different addresses or the same address from the two physical address spaces. In one example, two processors having different physical address spaces share some common memory locations for communicating between the processors. For example, the majority of the memory locations for each address space are not shared. The common memory locations are used to transfer data between the processors. Typically, the processors in this example run independently. However, when there is a need to share data, one processor places the data in a common or shared memory location that is accessible by the other processor.

Another address type is the local address used by a memory module to refer to one or more specific memory locations within that memory module. Each memory module has its own local address space. A memory module ID may be provided for each memory module. It then becomes possible to uniquely identify a memory location within a reconfigurable memory system by a two-tuple that contains a memory module ID and a local address. For convenience, this two-tuple can be thought of as addresses within a global address space. There is exactly one global address space in a reconfigurable memory system. Depending on the embodiment, global address space and global addresses may be an abstraction with no explicit physical manifestation.

Related to local addresses are the geographic address spaces. When a memory organization is configured to implement the physical address space of a processor group, a set of memory locations, possibly spread over multiple memory modules, are used as storage for that physical address space. This collection of memory locations forms the geographic address space of that physical address space. Mathematically, it is the projection of the physical address space into the global address space.

A translated address is the converted address output by an address translation unit 204. Its exact form varies in different embodiments as described in further detail below.

In some usage modes, a processor group may be running a general purpose operating system that supports virtual memory systems. Such an operating system provides each process running on it with its own virtual address space. Virtual address spaces are used by conventional operating systems, such as Windows, Linux, etc. When a process needs to access memory, its software may generate a virtual address in its virtual address space, which the processor it is running on then converts to a physical address. In some other usage modes that are common in embedded systems, software running on the processors generates physical addresses directly.

Thus, in summary of FIG. 2, a data request, such as a read or write request, from one of the processors 202 is sent to at least one of the address translation units 204. This request refers to at least one memory location in one or more of the memory modules 208 using a physical address. The address translation unit converts this physical address in the request to a translated address and transmits the request to the interconnection network 206. The interconnection network 206 routes the converted request to the appropriate memory module(s) of the modules 208 which may perform additional address conversion in order to identify the referenced memory locations using a local address. Each responding memory module then reads or writes data as requested. If data is read from a memory module, the memory module transmits the data to the interconnection network 206 which routes the data to the appropriate address translation unit 204. The address translation unit then transmits the data to the processor.

In one embodiment, the reconfigurable memory system 200 is configured to provide a suitable memory configuration for one or more operating systems that execute on one or more processors or processor groups 202. The purpose of a configuration, in this embodiment, is to allocate memory space within the memory modules 208 to provide an appropriate supply of memory for each operating system. Operating systems may have memory requirements that vary from application to application and from time to time. When a reconfiguration is performed to adjust the supply of memory for each operating system, the reconfigurable memory system 200 summarizes, for each operating system, the available physical memory that has been allocated for that operating system. An operating system may consult such a summary at operating system boot time, or more dynamically without rebooting, in order to revise its representation for usable physical addresses that can be used by applications.

In the following example, it is assumed that a contiguous range of physical addresses is provided for each operating system. When the reconfigurable memory system 200 is configured, address mapping tables are set within address translation unit 204 and memory modules 208 so that every address within a contiguous range of physical addresses references a unique location in one of the memory modules 208. The contiguous range of physical addresses is summarized by a beginning address and an ending address that define a usable physical address range. In this example, a memory module is configured and then an operating system is booted to take advantage of a controlled supply of available memory. At boot time, the operating system consults its physical address range summary and then adjusts its memory management system so as to utilize physical memory that lies within the summarized range. In this manner, each operating system is automatically configured to work in harmony with the memory configuration that has been provided by the reconfigurable memory system.

FIGS. 3A-B illustrate the several types of address spaces described above. Referring now to FIG. 3A, FIG. 3A illustrates an example of memory configurations available to the processor groups 202a and 202b at a time t1. FIG. 3B illustrates an example of memory configurations available to the processor groups 202a and 202b at a later time t2, after a reconfiguration of the memory configurations shown in FIG. 3A.

In addition to showing an example of memory configurations for the processor groups 202a and 202b, FIG. 3A illustrates the address spaces 300 available to the memory system 200, according to an embodiment. The address spaces 300 are logical representations of the memory made available to the processors 202 by the memory modules 208. The address spaces 300 illustrate how particular devices in the memory system 200 view the available memory. As described above, the address spaces are collections of addresses for each type of space.

Each process or application running in a general purpose operating system may have a virtual address space. Virtual address spaces 203a-c represent virtual address spaces for processes running on the processor group 202a. Virtual address spaces are used by conventional operating systems, such as Windows, Linux, etc. When a process needs to access memory, the process may generate a virtual address in its address space, which is mapped to a physical address. The processor group 202b may also have virtual address spaces, although not shown.

A physical address space is an address space as seen by a processor group after configuration. A processor group may include one or more processors. When a processor issues a memory request, the processor specifies a physical address in its physical address space to access memory available to the processor.

The physical address spaces 302a and 302b may each be contiguous and have a predetermined size. The processor group 202a only has knowledge of the physical address space 302a and does not need to know about other physical address spaces. In this regard, an off-the-shelf processor may be used because conventional processors are configured to access a physical address space. Also, the reconfigurable memory system 200 permits multiple physical address spaces to co-exist, and even share memory modules. For example, the processor group 202a only has knowledge of the physical address space 302a and the processor group 202b only has knowledge of the physical address space 302b, even though the physical address spaces 302a and 302b may simultaneously share memory modules.

In certain instances, physical address spaces may share memory locations in one or more memory modules. This is illustrated in FIG. 3B. The physical address spaces 302a and 302b share memory locations in the memory module 208e (MM7). The shared memory locations may be used to exchange data between the processor groups 202a and 202b. In this example, the shared memory locations are used judiciously in that data may be written to a shared memory location at any time by any of the processor groups 202a and 202b which typically run independently.

In FIG. 3A, the address translation unit 204a references two address spaces: the physical address space 302 of the processor group 202a and a translated address space 304 assigned to the processor group 202a. Each address within the physical address space 302a corresponds to an address within the translated address space 304. The address translation unit 204a maps addresses between the physical address space 302 and the translated address space 304. The actual form of the translated address space varies based on the different embodiments of the address translation unit 204a and other components, described in detail below. In one embodiment, if the address translation unit 204a is operable to generate a tuple including a memory module ID and local address in one of the memory modules 208, then the translated address space 304 may include local addresses of a memory module. In another embodiment, the address translation unit 204a may generate a processor group ID and physical address which is converted by the interconnection network 206 and an address manipulation unit, such as shown in FIGS. 6A-B and 7A-B, to a local address in the memory modules 208. Although not shown, the processor group 202b may also have a translated address space and is connected to the interconnection network 206.

The interconnection network 206 routes requests from the processor groups 202a and 202b to the memory modules 208. The interconnection network 206 also routes other requests from processor groups to the memory modules 208 assigned to a respective processor group after configuration. The interconnect network 206 may route requests for the processor group 202a from the translated address space 304 to a geographic address space 310a.

The geographic address space includes parts of one or more local address spaces, wherein the local addresses for a memory module comprise a local address space. If each memory module is assigned a unique ID, a geographic address may include (memory module ID, local address). In the example shown for the processor group 202a, the geographic address space 310a includes local addresses for the memory modules 208a and 208b. For the processor group 202b, the geographic space 310b includes local addresses for the memory modules 208b and 208c. Thus, the local address space for the memory module 208b is shared by two separate geographic address spaces. Section 308a of the local address space for the memory module 208b is used by the processor group 202a, and section 308b of the local address space of the memory module 208b is used by the processor group 202b. Each address within the translated address space 304 corresponds to an address within the local address spaces 306 or 308a.

Once configured, the reconfigurable memory system provides a local address in one of the local address spaces 306 or 308a for each address in the physical address space 302a accessed only by the processor group 202a, and provides a local address in one of the memory modules 208b (e.g., section 308b) and 208c for each physical address in the physical address space 302b only accessible by the processor group 202b. Thus, a physical address ffffcc generated by the processor group 202a may access a local address in the geographic address space 310a and the same physical address ffffcc generated by the processor group 202b may access a local address in the geographic address space 310b. Additionally, the processors, such as the processor in the processor groups 202a and 202b, access each address within the physical address spaces 302a and 302b as if it were local to the respective processor group. Therefore, processing and address conversions beyond the initial memory request are transparent to the processor groups 202a and 202b. Thus, the memory modules 308 may be reconfigured and the new configuration is transparent to the processor groups 202a and 202b, because they would still access the same physical address space unless the memory requirements for the processor groups 202a and 202b changed.

As described above, in the example shown in FIG. 3B, there are shared memory locations in the memory module 208e for the processor groups 202a and 202b. The shared memory locations, for example, may be used to exchange data between the processor groups 202a and 202b. For example, the processor group 202a may place data in a shared memory location in order to send data to the processor group 202b. The processor group 202b then accesses the shared memory location to retrieve the data from the processor group 202a. In one example, the processor groups 202a and 202b periodically check the shared memory locations to retrieve any new data placed in a shared memory location from the other processor group. The shared memory locations are not required and are shown to illustrate one type of memory configuration.

In FIG. 3B, there is shown a schematic diagram of memory spaces 300 available to the memory system 200 at a later time period t2 after the memory system 200 has been reconfigured. The processor group 202a originally stored data in memory modules 208a and 208b while the processor group 202b stored data in memory modules 208b and 208c as shown in FIG. 3A. At the time t2 after reconfiguration, the processor group 202a now stores data in memory modules 208d and 208e while the processor group 202b now stores data in memory modules 208e and 208f. As shown by reference to FIGS. 3A and 3B, memory modules 208 can be used for different processor groups at different time periods.

As mentioned above, the translated address space may vary depending on the level of translation performed at the address translation unit. In one embodiment, referred to as translation at root, the bulk of the translation is performed at the address translation unit. For example, the address translation unit 204a shown in FIG. 3A may translate a physical address to a geographic address (e.g., memory module ID, local address). Then, the interconnection network 206 routes a memory request to a specific memory module having the memory module ID in the geographic address space 310a. In another embodiment, referred to as translate at leaf, the bulk of the translation is performed near the memory modules rather than at the address translation unit. For example, the address translation unit 204a may convert a received physical address to a multicast address, a processor group ID and a physical address. The interconnection network 206 may multicast a memory request including the processor group ID and physical address (i.e., the translated address in this embodiment) to all the memory modules 208a and 208b in the geographic address space 310a. Then, an address manipulation unit coupled to each of the memory modules 208a and 208b may include logic for determining whether the memory request is directed to a local address in a memory module connected thereto.

FIGS. 3A and 3B illustrate the reconfigurable memory system configured differently at different times, i.e., configurable in time. The reconfigurable memory system is also configurable in space. That is when using different instances of a reconfigurable memory system designed with a similar set of memory modules and processors, the reconfiguration system is operable to generate one of multiple configurations depending on user specifications. For example, the configuration shown in FIG. 3A may be one example of a memory configuration for the processors groups 202a and 202b using one instance of a reconfigurable memory system. Alternatively, the configuration shown in FIG. 3B may be generated on another similarly design but different instance of the reconfigurable memory system.

FIG. 3C illustrates yet another example of a reconfiguration of the reconfigurable memory system. FIG. 3C illustrates the reconfigurable memory system configured differently at a time t3. FIG. 3C is provided to illustrate that in a first configuration a processor group has access to a memory location and a second processor group does not have access to the memory location. In a second configuration, the second processor group has access to the memory location and the first processor group does not. For example, at the time t2 shown in FIG. 3B, the processor group 202a has access to memory locations in the memory module 208d (MM6) and the processor group 202b does not have access to the memory locations in the memory module 208d. At the time t3, after a reconfiguration, the processor group 202b has access to memory locations in the memory module 208d (MM6) and the processor group 202a does not have access to the memory locations in the memory module 208d. FIG. 3C illustrates a reconfiguration in time, similar to FIG. 3B when compared to FIG. 3A, however, the example in FIG. 3C may also be a reconfiguration space. That is using the same set of memory modules and processors, the reconfiguration system is operable to generate one of multiple configurations depending on user specifications. FIGS. 3A-C are examples of the different memory configurations that may be generated.

FIGS. 4A-B illustrate different embodiments of an address translation unit, such as the address translation unit 204a shown in FIG. 3A. The address translation unit 204a converts physical addresses in a physical address space for a processor group to a translated address. Mapping tables may be used for converting the physical addresses. Generally tables may be used in many of the devices (e.g., address translation unit, address manipulation unit, and the interconnection network) in the reconfigurable memory system to perform address conversion. Address conversion may depend on the addresses received by each device and the addresses or related values populating the tables. These tables can be configured to take on different values, giving the reconfigurable memory system its configurability.

Two embodiments associated with address conversion performed at the address translation unit are the translated at leaf embodiment and the translated at root embodiment. In the translated at leaf embodiment, the bulk of the translation is performed at the memory module, which may include an address manipulation unit. As shown in FIG. 4A, the address translation unit 204a in this embodiment receives a data request from the processor group 204a including the processor group ID and a physical address 406. The address translation unit 204a uses the mapping table 402 to convert the processor group ID to a multicast address for multicasting the physical address and the data request to some or all of the memory modules in the physical address space 302a of the processor group 202a, shown as multicast message 408 in FIG. 4A. For example, the data request is multicasted via the interconnection network 206 to the memory modules 208a and 208b shown in FIG. 3A. The following is an example of the mapping table 402 in this translated at leaf embodiment:

| Processor group ID (key) | Multicast address (output) |
|---|---|
| X1 | MA1 |
| X2 | MA2 |
| X3 | MA3 |

In the above example, the processor group ID is used as a key to find a match in the mapping table 402. When a match is found, the output from the mapping table is the multicast address. In another embodiment where each address translation unit 204 is used by only one processor group, the mapping table 402 may be no more than a register holding a multicast address.

In the translation at root embodiment of the address translation unit 204a shown in FIG. 4B, the mapping table 402 is populated with different entries such that the physical address and the processor group ID 406 is converted using the mapping table 402 to a memory module ID and local address in the memory module. In some instances, a data request may reference data in more than one local address, and thus the mapping table 402 is used to identify the relevant one or more memory module IDs and local addresses. The memory module ID is used by the interconnection network 206 to route the data request to a specific memory module, and the local address is used to identify a specific memory location in the memory module. Examples of fields in the mapping table 402 in this translated at root embodiment may include processor group ID, physical address, memory module ID, and local address. The mapping table 402 for both embodiments may be created during configuration of the reconfigurable memory system 200. Alternatively, the mapping table 404 may be replaced by an algorithm or the like.

The address translation units may also coordinate multiple responses from memory modules. For example, if a physical address and data request are multicasted to multiple memory modules in a memory space, more than one memory module may respond. The address translation unit may receive multiple responses and coordinate them into a single response for the processor issuing the data request.

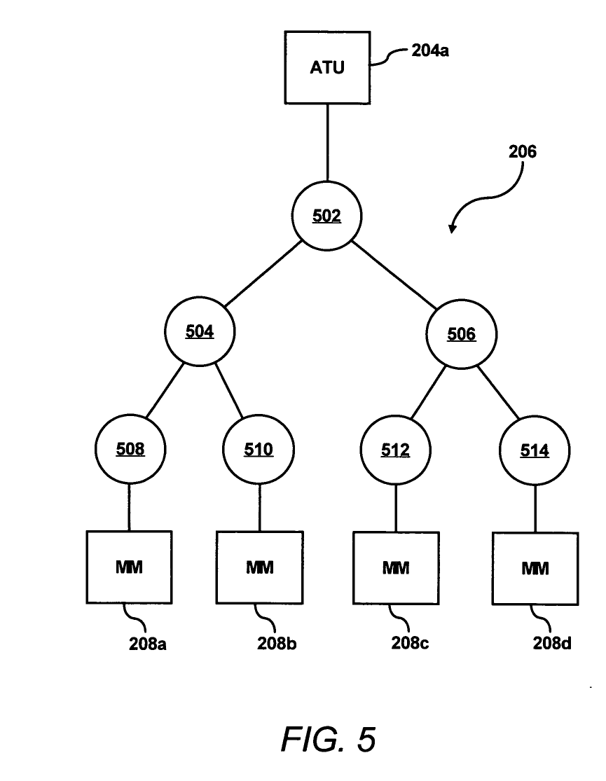

Referring now to FIG. 5, there is shown a schematic diagram of the interconnection network 206, according to an embodiment. The interconnection network 206 includes a plurality of nodes 502-514 for routing requests from the address translation units 204, which includes the address translation unit 204a shown in FIGS. 3A and 3B, to the memory modules 208, which include the memory modules 208a and 208b that make up the translated address space 304 for the processor group 202a shown in FIG. 3A.

In the translated at leaf embodiment, the address translation unit 204a transmits the multicast address and data request to the node 502 of the interconnection network 206 shown in FIG. 5. The node 502 includes an algorithm, routing table or the like for multicasting and routing the request to each of the memory modules 208a and 208b in the physical address space of the processor group 202a shown in FIG. 3A. For example, the nodes 504, 508, and 510 are used to multicast the data request to the memory modules 208a and 208b. In this manner, the data request reaches the memory modules 208a and 208b which may respond if the data request is associated with a local address of the respective memory module. If the request was a read request, the memory modules 208a and 208b transmit the read data to nodes 508 and 510 which route the data to the address translation unit 204a. In this example, the read request encompasses local addresses for both memory modules 208a and 208b. If the request was a write request, the data to be written is routed similarly to the memory modules 208a and 208b and the memory module with the memory locations performs the requested write. Additionally, the node 502 may include information for routing another request to the other memory modules 208c and 208d that make up another translated address space.

In the translated at root embodiment, the interconnection network 206 routes the data request according to the memory module ID shown in FIG. 4B. Accordingly, the nodes 502, 504, 508 and 510 include information for routing the request directly to the memory module based, for example, on the memory module ID. Accordingly, the nodes 502, 504, 508 and 510 include information for routing the request to only the memory module 208a or 208b that responds to the request.

Thus, by using the address translation unit 204a, the interconnection network 206, and possibly an address manipulation unit, the processor group 202a only needs to know an address in its physical address space to perform a memory access and the reconfigurable local address spaces of the memory modules are transparent to the processor group 202a.

FIGS. 6A-B illustrates embodiments of a memory module 208. FIG. 6A illustrates the memory module 208 used in the translated at root embodiment. In this embodiment, the memory module 208 may receive a signal 601 including a tuple of the memory module ID of the memory module 208 and the local address of one or memory locations referenced in a data request. The signal 601 also includes the request type, such as a read request or a write request. If the data request is a write request, data is included for storage in the memory locations. A different network, not shown, may be used for transmitting or receiving data in both the translated at root and the translated at leaf embodiments. The memory module 208 includes a RAM array for storing data and address decode logic 604 for addressing the RAM array using the local address.

FIG. 6B illustrates the memory module 208 used in the translated at leaf embodiment. In this embodiment, the memory module 208 includes an address manipulation unit 602 and the RAM array and address decode block 604. In this embodiment, the signal 601 includes a processor group ID and a physical address for performing a data request. The signal 601 also includes the request type, such as a read request or a write request. In this embodiment, the signal 601 is multicasted to all the memory modules in the physical address space of the processor group issuing the data request. The address manipulation unit 602 determines whether the data request is referencing memory locations in the memory module 208 and if so identifies the local addresses of the memory locations for performing the data request.

The address manipulation unit 602 is shown in greater detail in FIG. 7A and includes an address mapping table 702, an offset checking unit 704 and a local address calculation unit 706. In the translated at leaf embodiment, the address mapping table 702 receives the processor group ID and uses it to determine whether a match is found in the address mapping table 702 (i.e., whether the data request is possibly referencing a memory location in the memory module 208). If a match is found, an input to the AND gate 720 is enabled and the address manipulation unit 602 determines whether the memory module 208 includes a local address for the request. Also, if a match is found in the address mapping table 702, a local start offset signal 710, a local end offset signal 712 and a local base address signal 714 are output. The address mapping table 702 may be populated when the memory system is reconfigured by the table population unit 118 shown in FIG. 2.

In this particular embodiment, the portion of a processor group's physical address space mapped to a memory module occupies contiguous local addresses. The local base address 714 is the memory module's local address where this contiguous region begins. The start offset 710 is the processor group's physical address mapped to the local base address 714. The end offset 712 is the processor group's last physical address mapped to the memory module. As an example, FIG. 7B illustrates the local addresses within the memory module 208b. The memory module 208b is shared by two physical address spaces 302a and 302b as shown in FIG. 3A. In this example, the local addresses 0-10 shown in FIG. 7B are used by the physical address space 302a to support physical addresses 490 to 500 and the local addresses 11-100 shown in FIG. 7B are used by the physical address space 302b to support physical addresses 0 to 89. When a request bearing the processor group ID of address space 302a arrives at the address mapping table 702 shown in FIG. 7A, the address manipulation unit 602, in this example, finds a match in the address mapping table 702. This enables the signal “found match?” 708 and generates a local base address of 0, a start offset 710 of 490 and an end offset 712 of 500. Suppose the request has a physical address 492. The offset checking unit 704 determines whether this physical addresses is between the start offset 710 and end offset 712. In this case, it is and the offset checking unit 704 enables the input 718 to the AND gate 720 accordingly. The AND gate 720 then asserts enable 608, which enables the RAM array and address decode unit 604 to read or write data. If disabled, the RAM array and address decode unit 604 do nothing. The local address calculation unit 706 subtracts the start offsets 710 from physical address and adds the result to the local base address 714 to determine the local address 716, which in this example is the local address 2.

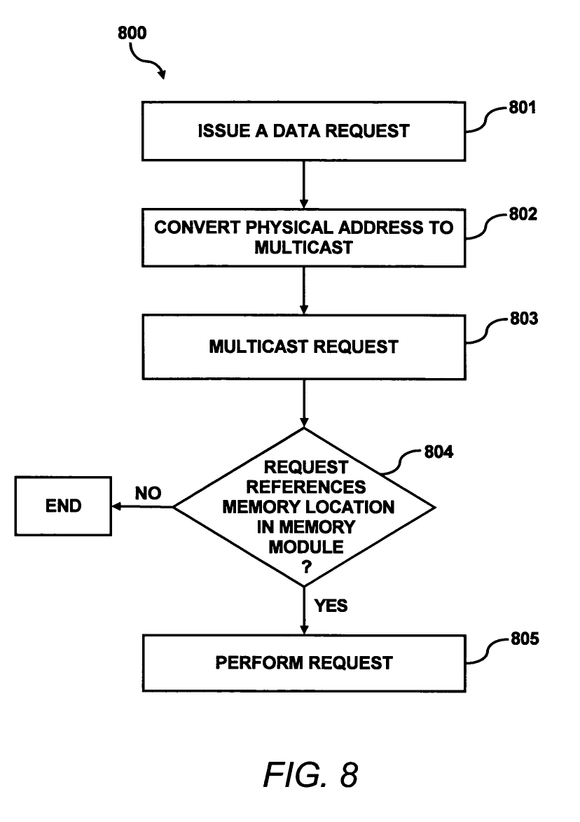

Referring to FIG. 8, there is illustrated a flow diagram of an operational mode 800 for the reconfigurable memory system 200, according to an embodiment. The operational mode 800 includes the translated at leaf embodiment described above using the address manipulation unit 602. The method 800 is described with respect to the reconfigurable memory system shown in FIGS. 1-4A, 5, 6B, and 7A-B and described above.

In the operational mode 800, the processor group 202a issues a read or write request to a physical address in step 801. The request includes the physical address and possibly the processor group ID, such as shown as 406 in FIG. 4A. The request is transmitted to the address translation unit 204a. The address translation unit 204a converts the physical address and processor group ID to a multicast address using the mapping table 402 at step 802. For example, the mapping table 402 identifies a multicast address for the memory modules provisioned for the processor group 202a, such as the memory modules in the geographic address space 310a shown in FIG. 3A. The address translation unit 204a multicasts the request to the memory modules having the multicast address via the interconnection network 206 at step 803.

At step 804, a memory module having the multicast address receives the request and determines whether the request is referencing a memory location in the memory module. For example, the address manipulation unit 602 shown in FIGS. 6B and 7 determines whether the request is referencing a memory location in the memory module. At step 805, if the request is referencing a memory location in the memory module, the request is performed. For example, for a read request, the data is read from the memory location and for a write request the data is written to the memory location. For a read request, the data is transmitted to the processor group 202a via the interconnection network 206.

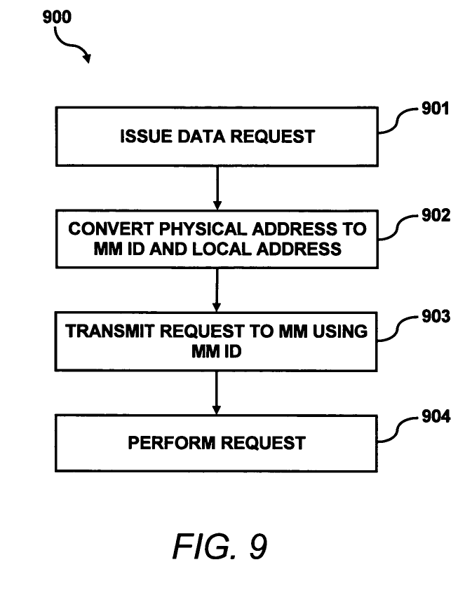

FIG. 9 illustrates another embodiment of an operational mode 900 for the reconfigurable memory system 200. The operational mode 900 is related to the translated at root embodiment described above. The method 900 is described with respect to the reconfigurable memory system shown in FIGS. 1-3C, 4B, 5, and 6A described above

In the operational mode 900, the processor group 202a issues a data request to a physical address 406 at step 901. The request includes the physical address and possibly the processor group ID, such as shown as 406 in FIG. 4B. The request is transmitted to the address translation unit 204a. The address translation unit 204a converts the physical address and processor group ID to a memory module ID for a memory module and a local address in the memory module 408 using the mapping table 402 at step 902. The address translation unit 204a transmits the request to the memory module having the memory module ID via the interconnection network 206 at step 903. At step 904, the memory module performs the data request. The local address in the request may be used to identify a memory location in the memory module for performing the request.

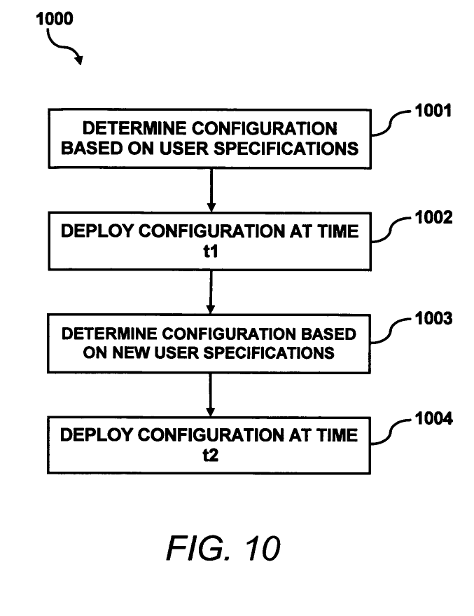

FIG. 10 illustrates a flow diagram of an embodiment for configuring the reconfigurable memory system 200. The method 1000 shown in FIG. 10 is described with respect to the reconfigurable memory system shown in FIGS. 1-7 by way of example and not limitation.

At step 1001, a configuration of the memory system is determined based on user specifications. For example, the compiler and optimizer 114 shown in FIG. 1 receives a list of available hardware 106, a list of logical platform specifications 108 provided by the user which together make up the user requirements and criteria 110 for configuring the available hardware 106. A list of metrics 112 is also input into the system 100. The system 100 then uses the compiler and optimizer 114 to determine how the available hardware 106 should be configured. This configuration is represented as a platform description 116 which is tested to determine if the platform will meet the requirements and criteria 110 and work within the metrics 112. If not, the compiler and optimizer 114 generate another configuration. This process is continued until a configuration satisfying the metrics 112 and requirements and criteria 110 is found. At step 1002, the system 100 then deploys the configuration, shown as the physical configuration 120 at a time t1. An example of a configuration is shown in FIG. 3A.

At step 1003, another set of user specifications are input into the compiler and optimizer 114 and a new configuration is determined. At step 1004, the system 100 then deploys another configuration at a later time t2. An example of this configuration is shown in FIG. 3B.

The method 1000 describes a method of configuring the memory system 200 at two different times based on different user requirements. It will be apparent that the memory system 200 comprising a predetermined set of processors and memory modules can be reconfigured in space. That is the memory system 200 can be configured in different manners, i.e., different memory modules may be provisioned for different processors, based on user requirements. Also, reconfiguring the memory system 200 may be accomplished at least in part by populating the address conversion tables described above to accommodate the different configurations.

Some of the steps illustrated in the operational modes 800 and 900 and the method 1000 may be contained as a utility, program, subprogram, in any desired computer accessible medium. For example, steps including address conversions may be implemented as a conversion program. Also, the configurations determined and tested by the compiler and optimizer 114 described in the method 1000 may also be performed by software. These and other steps may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

What has been described and illustrated herein are the embodiments along with some of its variations. The terms, descriptions and figures used herein are set forth by way of illustration only and are not meant as limitations. Those skilled in the art will recognize that many variations are possible within the spirit and scope of the embodiments, which intended to be defined by the following claims and their equivalents in which all terms are meant in their broadest reasonable sense unless otherwise indicated.

What is claimed is:

1. An apparatus comprising:
a reconfigurable memory system including:
a first memory module having a plurality of memory locations;
a first processor having access to a first physical address space;
a second processor having access to a second physical address space; and
a reconfiguration system reconfiguring the memory system wherein,
at a time t1, after a first configuration, the first processor is operable to access a first memory location in the first memory module by referencing a physical address in the first physical address space and the second processor cannot access the first memory location, and
at a time t2, after a second configuration, the second processor is operable to access the first memory location by referencing a physical address in the second physical address space and the first processor cannot access the first memory location.

2. The apparatus of claim 1, wherein at the time t1, the first processor and the second processor are configured to share at least one memory location in the first memory module.

3. The apparatus of claim 1, wherein the reconfigurable memory system further comprises an interconnection network; and
at the time t1, the interconnection network is operable to route a first read or write request generated by the first processor to at least one memory module in the reconfigurable memory system provisioned for the first processor; and
at the time t2, the interconnection network is reconfigured and is operable to route a second read or write request generated by the first processor to at least one memory module in the reconfigurable memory system provisioned for the first processor at the time t2.

4. The apparatus of claim 3, wherein the interconnection network is reconfigured at the time t2 by populating tables in the interconnection network with addresses associated with the reconfigured memory system for the first processor at the time t2.

5. The apparatus of claim 3, wherein the reconfigurable memory system further comprises at least one translation unit; and
at the time t1, the at least one translation unit is operable to translate a physical address for the first read or write request to a local address in the first memory module provisioned for the first processor at the time t1; and
at the time t2, the at least one translation unit is reconfigured and is operable to translate a physical address for the second read or write request to a local address in a second memory module provisioned for the first processor at the time t2.

6. The apparatus of claim 5, wherein the at least one translation unit is reconfigured by populating a mapping table in the at least one translation unit with addresses associated with the reconfigured memory system for the first processor at the time t2.

7. The apparatus of claim 5, wherein the at least one translation unit comprises an address translation unit; and
at the time t1, the address translation unit is operable to translate the physical address for the first read or write request to (1) the local address in the first memory module provisioned for the first physical address space and (2) a memory module ID for the first memory module provisioned for the first processor; and
at the time t2, the address translation unit is reconfigured and is operable to translate the physical address for the second read or write request to (1) a local address in the second memory module provisioned for the first processor at the time t2 and (2) a memory module ID for the second memory module provisioned for the first processor at the time t2.

8. The apparatus of claim 5, wherein the at least one translation unit comprises an address translation unit; and
at the time t1, the address translation unit is operable to translate the physical address for the first read or write request to a first multicast address associated with memory modules provisioned for the first processor; and
at the time t2, the address translation unit is operable to translate the physical address for the second read or write request to a second multicast address associated with memory modules provisioned for the first processor at the time t2.

9. The apparatus of claim 8, wherein the address translation unit multicasts the first and second read or write requests via the interconnection network.

10. The apparatus of claim 8, wherein the at least one translation unit further comprises an address manipulation unit for a memory module provisioned for the first processor; and the address manipulation unit is operable to receive the first multicasted message and determine whether a read or write request in the multicasted message is associated with data stored in the memory module provisioned for the first processor.

11. The apparatus of claim 10, further comprising means for coordinating multiple responses to a multicasted read request.

12. The apparatus of claim 1, wherein the reconfigurable memory system is operable to be reconfigured at the time t2 by loading new addresses and at least one new offset into an address conversion table.

13. The apparatus of claim 1, wherein the reconfigurable memory system comprises:
a plurality of processor chips, the first processor and the second processor being processor chips in the plurality of processor chips; and
a plurality of memory chips; the first memory module being a memory chip in the plurality of memory chips; wherein the reconfiguration system is operable to provision the plurality of memory chips for the plurality of processor chips.

14. The apparatus of claim 1, wherein at the time t1, the first processor has access to a first set of memory locations in the first memory module and the second processor has access to a second set of memory locations in the first memory module different from the first set of memory locations.

15. The apparatus of claim 1, wherein the first processor runs an operating system supporting virtual memory.

16. The apparatus of claim 1, wherein the reconfigurable memory system further comprises an interconnection network; and
at the time t1, the interconnection network is operable to route a first read or write request generated by the first processor to the first memory module provisioned for the first processor and does not route the first read or write request to a memory module not provisioned for the first processor; and
at the time t2, the interconnection network is reconfigured and is operable to route a second read or write request generated by the first processor to a memory module configured for the first processor at the time t2 and does route the second read or write request to a memory module not provisioned for the first processor at the time t2.

17. An apparatus comprising:
a plurality of processors including a first processor having access to a first physical address space and a second processor having access to a second physical address space;
a plurality of memory modules;
a reconfiguration system operable to generate a first configuration of the plurality of processors and memory modules or a second configuration, different than the first configuration, of the plurality of processors and memory modules; and wherein
in the first configuration the first processor is operable to access a first memory location in a first memory module of the plurality of memory modules by referencing a physical address in the first physical address space and the second processor cannot access the first memory location; and
in the second configuration the second processor is operable to access the first memory location by referencing a physical address in the second physical address space and the first processor cannot access the first memory location.

18. The apparatus of claim 17, wherein in the first configuration, the first processor and the second processor are configured to share at least one memory location in the first memory module.

19. The apparatus of claim 17, wherein in the first configuration, the first processor has access to a first set of memory locations in the first memory module and the second processor has access to a second set of memory locations in the first memory module different from the first set of memory locations.

20. The apparatus of claim 17, wherein the reconfigurable system further comprises a reconfigurable interconnection network operable to be configured to route data requests between at least one of the plurality of processors and at least one of the plurality of modules in the first configuration and is also operable to be configured to route data requests between at least one of the plurality of processors and at least one of the plurality of modules in the second configuration.

21. The apparatus of claim 20, wherein the interconnection network is configured by populating tables in the interconnection network with addresses associated with either the first configuration or the second configuration.

22. The apparatus of claim 17, wherein the reconfigurable system further comprises at least one reconfigurable translation unit operable to translate a physical address for a data request to a local address in a memory module of the plurality of memory modules in the first configuration and is also operable to be configured to translate a physical address for a data request to a local address in a memory module of the plurality of memory modules in the second configuration.

23. The apparatus of claim 22, wherein the at least one translation unit is configured by populating a mapping table in the at least one translation unit with addresses associated with either the first configuration or the second configuration.

24. The apparatus of claim 22, wherein the at least one translation unit comprises an address translation unit configurable for either the first or second configuration to translate the physical address to (1) the local address in the memory module and (2) a memory module ID for the memory module.

25. The apparatus of claim 23, wherein the at least one translation unit comprises an address translation unit operable to multicast the data request to memory modules provisioned for a processor of the plurality of processors generating the data request.

26. The apparatus of claim 25, wherein the at least one translation unit further comprises an address manipulation unit for each of the memory modules provisioned for the processor generating the data request, wherein each address manipulation unit is operable to receive the multicasted message and determine whether the data request is associated with data stored in the memory module.

27. The apparatus of claim 25, further comprising means for coordinating multiple responses to the multicasted data request.

28. The apparatus of claim 17, wherein the reconfigurable system is operable to be reconfigured by loading new addresses and at least one new offset into an address conversion table.

29. The apparatus of claim 17, wherein the reconfiguration system comprises:
a plurality of processor chips including the plurality of processors; and
a plurality of memory chips including the plurality of memory modules; wherein the reconfiguration system is operable to provision the plurality of memory chips for the plurality of processor chips based on the configuration that is generated.

30. The apparatus of claim 17, wherein the reconfigurable system further comprises a reconfigurable interconnection network operable to be configured to (1) route data requests between at least one of the plurality of processors and at least one of the plurality of modules provisioned for the at least one processor in the first configuration and not route data requests to a memory module not provisioned for the at least one processor in the first configuration, and (2) route data requests between at least one of the plurality of processors and at least one of the plurality of modules provisioned for the at least one processor in the second configuration and not route data requests to a memory module not provisioned for the at least one processor in the second configuration.

31. A method of reconfiguring a reconfigurable memory system including a first processor, a second processor and a first memory module, the method comprising:
configuring the memory system at a time t1, wherein the first processor is operable to access a first memory location in the first memory module and the second processor cannot access the first memory location; and
configuring the memory system at a later time t2, wherein the second processor is operable to access the first memory location and the first processor cannot access the first memory location.

32. The method of claim 31, wherein configuring the memory system at a time t1 further comprises configuring the memory system at the time t1 based on a first set of user requirements.

33. The method of claim 32, wherein configuring the memory system at a later time t2 further comprises configuring the memory system at the time t2 based on a second set of user requirements different from the first set.

34. The method of claim 31, wherein configuring the memory system at a time t1 further comprises populating address conversion tables to allow the first and second processor to access memory modules provisioned for the first and second processor at the time t1.

35. The method of claim 34, wherein configuring the memory system at a later time t2 further comprises populating address conversion tables to allow the first and second processor to access memory modules provisioned for the first and second processor at the time t2.

36. A method of handling requests in a reconfigurable memory system having a plurality of memory modules and processors, the method comprising:
receiving a data request, the request including a physical address for a processor of the plurality of processors generating the request;
converting the physical address to one of (1) a memory module ID for a memory module of the plurality of memory modules and (2) a multicast address for a group of memory modules of the plurality of memory module provisioned for the processor; and
routing the request to one of (1) the memory module using the memory module ID and (2) the group of memory modules.

37. A reconfigurable memory system, comprising:
means for provisioning a plurality of memory modules for a processor group;
means for receiving a data request generated by the processor group, the request including a physical address in a physical address space for the processor group; and
means for converting the physical address to an address used to reference a memory location in at least one of the plurality of memory modules to execute the data request.

38. The system of claim 37 further comprising means for routing the request to the at least one memory module.
